(19) United States
(12) Patent Application Publication
(10) Pub. No.: US 2015/0064089 A1
(43) Pub. Date: Mar. 5, 2015

(54) FLUIDIZED BED REACTORS INCLUDING CONICAL GAS DISTRIBUTORS AND RELATED METHODS OF FLUORINATION

(71) Applicant: HONEYWELL INTERNATIONAL INC., Morristown, NJ (US)

(72) Inventors: Terris Yang, Kenmore, NY (US); Robert Johnson, Lancaster, NY (US); Hsueh Sung Harry Tung, Getzville, NY (US)

(21) Appl. No.: 14/013,900

(22) Filed: Aug. 29, 2013

(51) Int. Cl. B01J 8/18; C01G 43/06

(52) U.S. Cl. CPC B01J 8/1818; C01G 43/066; B01J 2208/00938
USPC 423/258; 422/143

(57) ABSTRACT

Embodiments of a fluidized bed fluorination reactor are provided, as are embodiments of a fluidized bed reactor and embodiments of a fluorination method carried-out utilizing a fluidized bed fluorination reactor. In one embodiment, the fluidized bed fluorination reactor includes a source of fluorine gas, a reaction vessel, a windbox fluidly coupled to the source of fluorine gas, and a conical gas distributor fluidly coupled between the reaction vessel and the windbox. The conical gas distributor has a plurality of gas flow openings directing fluorine gas flow from the windbox into the fluorination reaction vessel during the fluorination process.

### TECHNICAL FIELD

The present invention relates generally to fluidized bed processing and, more particularly, to embodiments of a fluidized bed fluorination system including a conical gas distributor that improves solids-gas mixing and eliminates dead zones within a reaction vessel, as well to fluorination methods carried-out utilizing such a fluidized bed fluorination system.

### BACKGROUND

Fuel for nuclear power plants is commonly produced by uranium enrichment processes requiring uranium hexafluoride (UF6) as a feed/input. UF6 is, in turn, commonly produced by the fluorination of uranium hexafluoride (UF4). During one known fluorination process, solid UF4 is introduced into a fluidized bed reaction vessel (commonly referred to as a “fluorinator”) and reacted with fluorine gas at elevated temperatures to yield the desired product, gaseous UF6. The fluidized bed commonly contains an inert diluent material, such as calcium fluoride (CaF2; also commonly referred to as “fluorspar”), magnesium fluoride, or alumina, to improve the quality of fluidization and to moderate the reaction kinetics (e.g., to dissipate the considerable amounts of heat generated during the fluorination process). A gas distributor, which has traditionally assumed the form of a flat perforated or sintered plate (or grate) positioned near the bottom of the reaction vessel, is utilized to introduce the fluorine gas along with other fluidizing gases into the reaction vessel. The flat plate gas distributor provides high velocity gas flow into the reaction vessel to enhance fluidization of the bed material and to discourage back flow of the gaseous and solid materials through the distributor. The gaseous UF6 produced by the fluorination reaction is withdrawn from the reaction vessel through an upper manifold and then subjected to further downstream processing (e.g., filtering, purification, scrubbing, desubliming, condensation, and distillation).

During the above-described fluorination process, solids may aggregate within the reaction vessel and form relatively large, rock-like particles due to the highly reactive nature of fluorine, the heat released by the fluorination reaction, and impurities present within the bed material and UF4. Such aggregate masses tend to accumulate on the flat plate gas distributor and, specifically, within dead zones along the upper face of the gas distributor that remain relatively undisturbed by high velocity gas flow (note that the gas distributor dead zones generally cannot be eliminated by simply increasing the density of the gas flow openings through the gas distributor without negatively impacting the overall quality of fluidization). The solid aggregates may gradually grow so large as to cause critical operational issues within the reaction vessel, such as the obstruction of gas flow openings in the flat plate gas distributor and the development of hot spots within the reaction vessel. While some reaction vessels employ vertically-extending, sidewall-mounted drain pipes to remove solid aggregates from an area above the flat plate gas distributor, such drain pipes are typically limited in the amount of solid aggregates they are able to remove. Thus, even when the reaction vessel is equipped with such a sidewall-mounted drain pipe, solids may still aggregate on the flat plate gas distributor, particularly in sections far removed from the sidewall-mounted drain pipe, and eventually grow sufficiently large to force shutdown of the reaction vessel and cleaning of the gas distributor, which adds undesired expense and delay to the fluorination process.

It would thus be desirable to provide embodiments of fluidized bed fluorination reactor wherein the aggregation of solids within a reaction vessel is minimized. Ideally, embodiments of such a fluidized bed fluorination reactor would employ a unique fluorine gas distributor providing improved gas flow characteristics within the reaction vessel, such as improved solids-gas mixing within the reaction vessel to increase the mass and heat transfer between solids and gas phases during fluorination. It would further be desirable to provide embodiments of a fluidized bed reactor suitable for carrying-out such a fluorination process or other fluidized reaction wherein the accumulation of solids is minimized and wherein solids-gas mixing is improved. It would still further be desirable to provide embodiments of a fluorination process performed utilizing a fluidized bed fluorination reactor and providing the above-noted advantages. Other desirable features and characteristics of the present invention will become apparent from the subsequent Detailed Description and the appended Claims, taken in conjunction with the accompanying Drawings and the foregoing Background.

### BRIEF SUMMARY

Embodiments of a fluidized bed fluorination reactor are provided. In one embodiment, the fluidized bed fluorination reactor includes a source of fluorine gas, a reaction vessel, a windbox fluidly coupled to the source of fluorine gas, and a conical gas distributor fluidly coupled between the reaction vessel and the windbox. The conical gas distributor has a plurality of gas flow openings directing fluorine gas flow from the windbox into the fluorination reaction vessel during the fluorination process.

Embodiments of a fluidized bed reactor are further provided. In one embodiment, the fluidized bed reactor includes a source of gaseous reactant, a reaction vessel, a windbox fluidly coupled to the source of gaseous reactant, and a conical gas distributor fluidly coupled between the reaction vessel and the windbox. The conical gas distributor has a plurality of gas flow openings directing gaseous reactant flow from the windbox and into the reaction vessel during the reaction.

Embodiments of a fluorination process are further provided, which are carried-out utilizing a fluidized bed fluorination reactor of the type that includes a reaction vessel and a conical gas distributor having a plurality of gas flow openings formed therein. In one embodiment, the fluorination process includes the steps of supplying uranium tetrafluoride to the reaction vessel, and directing fluorine gas into the reaction vessel through the conical gas distributor and along a plurality of gas flow paths that are non-parallel with the longitudinal axis of the reaction vessel to support a fluorination reaction yielding uranium hexafluoride.

### BRIEF DESCRIPTION OF THE DRAWINGS

At least one example of the present invention will hereinafter be described in conjunction with the following figures, wherein like numerals denote like elements, and:

FIG. 1 is a simplified flow schematic of a fluidized bed fluorination reactor illustrated in accordance with an exemplary embodiment of the present invention;

FIG. 2 is a cross-sectional view of a windbox, a conical gas distributor, a solids drain pipe, and a fluorine inlet pipe suitable for inclusion within the exemplary fluidized bed fluorination reactor shown in FIG. 1 and illustrated in accordance with an exemplary embodiment; and

FIG. 3 is a top-down plan view of the exemplary conical gas distributor shown in FIG. 2 illustrating one manner in which the gas flow openings provided through the conical support wall of the gas distributor may be arranged.

### DETAILED DESCRIPTION

The following Detailed Description is merely exemplary in nature and is not intended to limit the invention or the application and uses of the invention. Furthermore, there is no intention to be bound by any theory presented in the preceding Background or the following detailed description.

Although described below in conjunction with a particular type of fluidized bed reactor, namely, a fluorination reactor, embodiments of the fluidized bed reactor can be utilized to carry-out other types of fluidized bed reactions, such as fluidized bed hydro-fluorination and reduction reactions, oxidation reactions, or chlorination reactions. This notwithstanding, embodiments of the fluidized bed reactor described below are particularly well-suited for carrying-out fluorination reactions wherein aggregation of solids is especially problematic due, at least in part, to the highly reactive nature of fluorine and the tremendous amounts of heat generated by the fluorination reaction. Thus, in preferred embodiments, and by way of non-limiting example only, the fluidized bed reactor is implemented as a fluidized bed fluorination reactor suitable for carrying-out the fluorination of, for example, uranium tetrafluoride (UF4) to yield uranium hexafluoride (UF6).

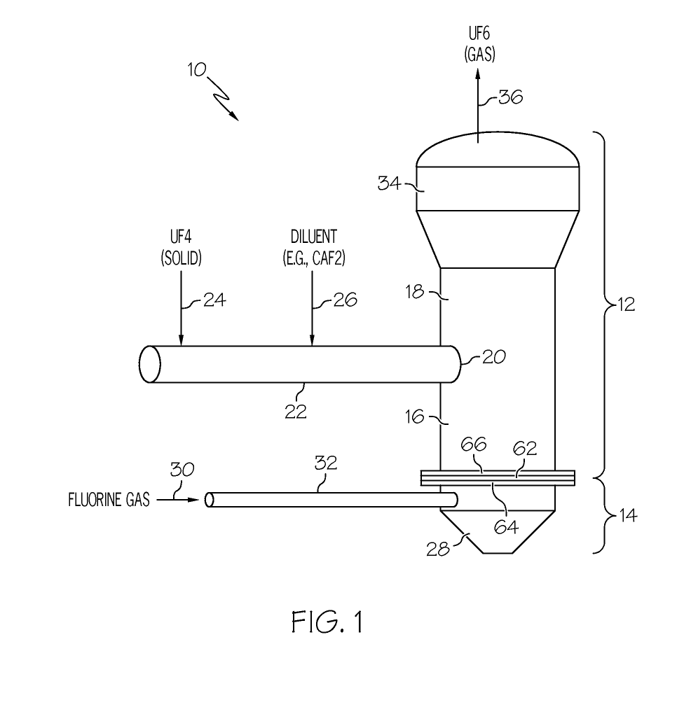

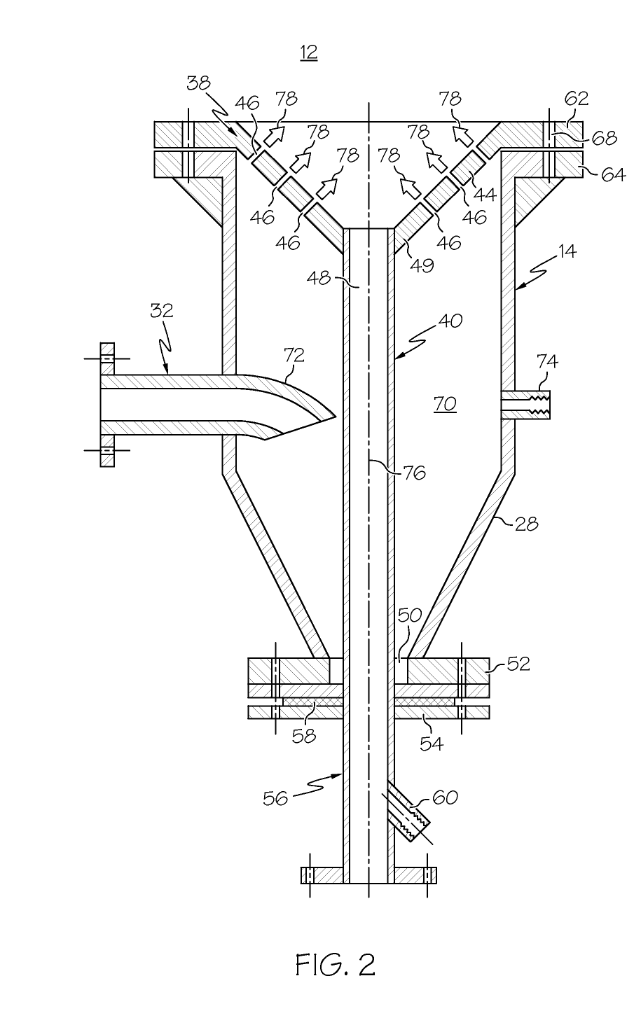

FIG. 1 is a simplified flow schematic of a fluidized bed fluorination reactor 10 illustrated in accordance with an exemplary embodiment of the present invention. Fluidized bed fluorination reactor 10 includes a reaction vessel 12 and a windbox 14, which is mounted to a lower section of reaction vessel 12. Reaction vessel 12 includes a shell 16 defining a reaction chamber 18, which is fluidly coupled to windbox 14 and, specifically, to a gas-receiving chamber provided within windbox 14 (shown in FIG. 2 and described below). A solids inlet 20 is provided through the sidewall of reaction vessel 12 and, during operation of fluorination reactor 10, receives solids from a solids conduit 22. In particular, solids conduit 22 receives UF4 and a diluent from a UF4 source 24 and diluent source 26, respectively, and conducts the UF4 and diluent into reaction chamber 18 of reaction vessel 12. Although fluidized bed fluorination reactor 10 is by no means limited to usage with a particular type of diluent, the diluent preferably contains or consists entirely of calcium fluoride (CaF2), also commonly referred to as “fluorspar.” By way of non-limiting example, the UF4 may be produced pursuant to the dry fluoride volatility process developed and commercially implemented by the assignee of the Instant Application, Honeywell International, Inc., currently headquartered in Morristown, N.J. In one implementation, a uranium oxide mixture (commonly referred to as “yellowcake”) may be first be uniformly sized and subjected to reduction process during which the yellowcake is reacted with hydrogen at high temperatures to produce uranium dioxide (UO2). A fluidized-bed hydro-fluorination process may then be performed during which the UO2 is reacted with anhydrous hydrofluoric gaseous acid to produce UF4 or “green salt” for usage within the fluorination reaction described herein.

Windbox 14 includes a shell 28 defining an interior chamber, which is fluidly coupled to a source of fluorine gas 30 by way of a fluorine inlet pipe 32. As utilized herein, the term “pipe” encompasses all types of flow conduits, as well as assemblies of flow conduits joined in fluid communication. The fluorine gas, which may be generically referred to as a “fluidizing gas” herein, flows through inlet pipe 32 into windbox 14, through a conical gas distributor (hidden from view in FIG. 1), and into reaction chamber 18 of reaction vessel 12. Variable amounts of inert diluent gas may also be provided in conjunction with the fluorine gas. Within reaction chamber 18, the fluorine gas reacts with the solid UF4 introduced into chamber 18 by way of solids conduit 22 to yield the desired product, gaseous UF6. The gaseous UF6 collects within an upper manifold 34 included within reaction vessel 12 and is ultimately withdrawn as a product stream through an upper conduit 36. The product stream containing the UF6 may then be subjected to further downstream processing utilizing additional processing equipment, which is conventionally known within the uranium conversion industry and which is not illustrated in FIG. 1 for clarity. For example, the products stream may be first passed through a series of filters to remove any unreacted UF4 and solid diluent therefrom and subsequently passed through a series of cold traps to chill the product stream and thereby desublimate the gaseous UF6 contained therein, thereby removing gaseous diluents. The UF6 may then be distilled or otherwise purified to complete the uranium conversion process. The diluent directed into reaction chamber 18 in conjunction with the UF4 improves the overall quality of fluidization and helps to dissipate the considerable amounts of heat released by the fluorination reaction.

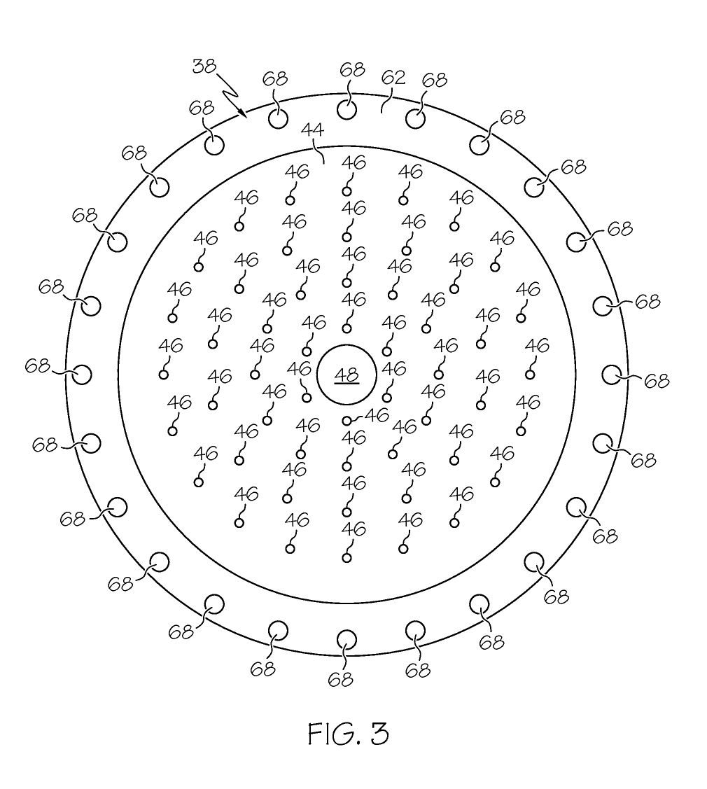

A perforated flat plate gas distributor has traditionally been employed to conduct the fluorine gas from windbox 14 into reaction chamber 18 of reaction vessel 12. The flat plate gas distributor, which typically assumes the form of a disk or grate-like structure, also supports the fluidized bed held within reaction vessel 12. As noted above, such perforated flat plate gas distributors do not achieve optimal gas-solids mixing and are prone to the accumulation of solid aggregates thereon. The aggregation of solids is especially problematic in the context of fluorination reactions due, at least in part, to the highly reactive nature of fluorine, to the highly exothermic nature of the fluorination reaction, and to impurities unavoidably present within the UF4 and bed materials. To mitigate the above-described problems, and specifically to provide improved gas-solids mixing and a significant reduction in the accumulation of solids within the reaction vessel and over the gas distributor, fluidized bed fluorination reactor 10 is equipped with a unique conical gas distributor and, in preferred embodiments, further with a solids drain pipe fluidly coupled to a central opening provided in the conical gas distributor. An example of such a conical gas distributor and central solids drain pipe is described more fully below in conjunction with FIGS. 2 and 3.

FIG. 2 is a cross-sectional view of windbox 14 and fluorine inlet pipe 32 shown in FIG. 1 and further illustrating a conical gas distributor 38 and a solids drain pipe 40 (also referred to as a “downcomer pipe”). Conical gas distributor 38 includes a conical support wall 44 through which a plurality of gas flow openings 46 is formed. The shape of conical support wall 44 and the shape, size, disposition, and dimensions of gas flow openings 46 are optimized to promote solids-gas mixing within reaction vessel 12 and the drainage of aggregate solids, as described more fully below in conjunction with FIG. 3. In addition to gas flow openings 46, conical gas distributor 38 includes a solids opening 48 formed through a central portion 49 of conical support wall 44. Solids drain pipe 40 extends through a portion of windbox 14 in a generally upward or vertical direction and into solids opening 48. The upper end section of solids drain pipe 40 is thus fluidly coupled to solids opening 48, as well as mechanically coupled (e.g., welded or threadably attached) to the inner circumferential surface of conical support wall 44 defining solids opening 48. In the illustrated example, the lower end portion of solids drain pipe 40 extends through an opening 50 provided in the bottom of conical gas distributor 38. In this case, conical gas distributor 38 may include a lower flange 52, which is affixed to an upper flange 54 of a drainpipe mounting structure 56; an annular seal or gasket 58 may be disposed between flanges 52 and 54 to prevent leakage; and a port 60 may be fluidly coupled to solids drain pipe 40 to enable purging with an inert gas (e.g., nitrogen), as may be appropriate to clear drain pipe 40 of any solid debris that should become lodged therein. This example notwithstanding, solids drain pipe 40 may alternatively have a gently curved geometry and an intermediate section of solids drain pipe 40 may extend through a sidewall of windbox 14; in such an alternative embodiment, the solids are not discharged from the lowest vertical section of the windbox, which can be advantageous when vertical space is limited. Furthermore, while the lower end of solids drain pipe 40 connects directly to solids opening 48 in the illustrated example, this is by no means necessary; in alternative embodiments, solids drain pipe 40 may be connected to solids opening 48 by use of a male-female type coupling, or similar coupling to achieve the most desirable connection.

While conical gas distributor 38 can be mounted between reaction vessel 12 (FIG. 1) and windbox 14 in a variety of different manners, it is generally preferred that the mounting means utilized provides sufficient structural strength and integrity to reliably support the weight of the fluidized bed within reaction vessel 12 (FIG. 1) and to prevent leakage through thermal cycling of vessel 12. In the illustrated example, specifically, conical gas distributor 38 further includes an annular mounting flange 62, which extends radially outward from the outer circumferential surface of conical support wall 44. As utilized herein, the term “annular mounting flange” encompasses a continuous annular structure or wall, as well as a plurality of radially-extending tabs. As indicated in FIG. 2, annular mounting flange 62 may be captured between an upper flange 64, which extends radially outward from the upper end of windbox 14, and a lower flange 66 (shown in FIG. 1), which extends radially outward from the lower end of reaction vessel 12 (FIG. 1); and a plurality of fastener openings 68 may be provided through flanges 62, 64, and 66 to receive a plurality of bolts or other such fasteners (not shown) and thereby secure reaction vessel 12 (FIG. 1), conical gas distributor 38, and windbox 14 together, including such gasketing as needed to achieve a leak-tight configuration.

The dimensions of conical gas distributor 38, the material or materials from which gas distributor 38 is formed, and the manner in which gas distributor 38 is fabricated will inevitably vary amongst different embodiments. However, by way of non-limiting example, it is noted that gas distributor 38 is preferably formed from a high temperature metal or alloy and fabricated to have a single piece or unitary construction. Gas flow openings 46 can be formed through conical support wall 44 of gas distributor 38 utilizing a suitable drilling process, such as mechanical drilling or laser drilling. If desired, the mouths or inlets of gas flow openings 46 (i.e., the bottom ends of openings 46 in the illustrated orientation) may be chamfered. While by no means limited to a particular range of thicknesses, conical support wall 44 and annular mounting flange 62 of gas distributor 38 are preferably fabricated to be sufficiently thick to support the fluidized bed held within reaction vessel 12 (FIG. 1); e.g., in one implementation, conical support wall 44 and annular mounting flange 62 may have a substantially consistent thickness of approximately 0.5 inch.

With continued reference to the exemplary embodiment illustrated in FIG. 2, fluorine inlet pipe 32 extends through an outer annular sidewall of windbox 14 to fluidly couple the inner windbox chamber 70 to the source of fluorine gas (generically represented in FIG. 1 by arrow 30). In a preferred embodiment, the outlet end 72 of fluorine inlet pipe 32 points in a generally downward direction to direct the flow of fluorine gas toward the lower portion of windbox 14 and away from conical gas distributor 38. In this manner, the flow rate of fluorine gas flow through the gas flow openings 46 closer to the outlet of fluorine inlet pipe 32 can be brought into alignment with the gas flow through the openings 46 further from the discharge of pipe 32 to improve overall uniformity of gas flow through conical gas distributor 38. As shown in FIG. 2, this may be accomplished by imparting outlet end 72 of fluorine inlet pipe 32 with a downwardly-tilting geometry. As further shown in FIG. 2, an auxiliary port 74 may be provided through the annular sidewall of windbox 14 to facilitate pressure measurements.

As noted above, the shape of conical support wall 44 and the shape, size, disposition, and dimensions of gas flow openings 46 are optimized to promote solids-gas mixing within reaction vessel 12 and drainage of aggregate solids through solids drain pipe 40. With respect to conical support wall 44, in particular, it will be readily appreciated that conical support wall 44 converges toward solids opening 48 and, thus, the inlet of solids drain pipe 40. Conical support wall 44 preferably has a substantially smooth outer surface and a sufficient slant or declination to promote gravity flow of solids into solids openings 48 and, therefore, into solids drain pipe 40 for reliable and continual removal of the aggregate solids from reaction vessel 12 (FIG. 1). In one exemplary embodiment, conical support wall 44 forms an angle with the longitudinal axis of reaction vessel 12 (represented in FIG. 2 by dashed line 76) between approximately 30° and 75°, as taken in cross-section along a plane parallel to longitudinal axis 76. In a more preferred embodiment, conical support wall 44 forms an angle with the longitudinal axis of reaction vessel 12 between approximately 45° and 65°.

Gas flow openings 46 are preferably configured to provide high velocity gas flow from windbox 14 into reaction vessel 12 (FIG. 1). In contrast to conventional flat plate gas distributors of the type described above, gas flow openings 46 are non-parallel with the longitudinal axis 76 of reaction vessel 12 (FIG. 1). Stated differently, the longitudinal axes of gas flow openings 46 each form a predetermined angle with the longitudinal axis 76 of reaction vessel 12 (FIG. 1) of, for example, approximately 30°-75°. The longitudinal axes of gas flow openings 46 may or may not be orthogonal to the major faces of conical support wall 44. As indicated in FIG. 2 by arrows 78, gas flow openings 46 may be configured to direct fluorine gas along flow paths that converge toward the longitudinal axis 76 of reaction vessel 12. By directing high velocity gas flow along paths that are non-parallel with the longitudinal axis 76 of reaction vessel 12 (FIG. 1), the length of the gas flow path and, thus, the residence time of the fluorine gas within reaction chamber 18 of reaction vessel 12 (FIG. 1) is increased. This, in turn, results in an increased contact time of the solids and gasses, and therefore improved heat and mass transfer, during the fluorination process.

In a preferred embodiment, gas flow openings 46 cooperate to create vortices-like fluorine flow within a bottom portion of reaction vessel 12 immediately above conical gas distributor 38 to increase agitation of the fluidized bed and further improve solids-gas mixing. The creation of gas flow vortices within a bottom portion of reaction vessel 12 may be enhanced by imparting gas flow openings with a distribution or spatial arrangement that is non-symmetrical. The creation of gas flow vortices, along with a substantially widespread distribution of gas flow openings 46, also helps reduce or eliminate the formation of dead zones across the upper surface of conical gas flow distributor 38. Each gas flow opening 46 preferably has a substantially straight or non-tortuous geometry to optimize gas flow velocity. Although not shown in FIG. 2, gas flow openings 46 may be imparted with a nozzle-like geometry wherein the flow area converges toward the outlet ends of openings 46 to further improve gas flow velocity. The dimensions of gas flow openings 46 may be determined based, at least in part, on the desired operational parameters of fluidized bed fluorination reactor 10 (FIG. 1) and the physical characteristics of the reactants and diluent (e.g., the weight of the fluorine gas as compared to the weight of the diluent). Gas flow openings 46 are further preferably arranged or distributed such that the gas flow rate through a central portion of conical gas distributor 38 exceeds the gas flow rate through an outer portion of distributor 38 so as to concentrate high velocity gas flow near the center of distributor 38 over which solids are more likely to aggregate. Due, at least in part, to the above-described characteristics of gas flow openings 46, the high velocity flow of fluorine into reaction vessel 12 (FIG. 1) provided by conical gas distributor 38 provides an enhanced solids-gas mixing, and therefore improved heat and mass transfer, during the fluorination process.

FIG. 3 is a top-down plan view of conical gas distributor 38 illustrating one manner in which gas flow openings 46 provided through conical support wall 44 may be arranged. In this particular example, gas flow openings 46 are arranged in a plurality of substantially concentric rings or circles. More specifically, and by way of non-limiting example only, a total of fifty four gas flow openings are shown in FIG. 3 and arranged in the following pattern: (i) an innermost ring of six substantially equally-spaced openings, (ii) an inner-middle ring of twelve substantially equally-spaced openings, (iii) a middle ring of twelve substantially equally-spaced openings, (iv) an outer-middle ring of fourteen substantially equally-spaced openings, and (v) an outermost ring of substantially twenty substantially equally-spaced openings. Gas flow openings 46 are further non-symmetrically distributed in an angularly staggered pattern to promote the formation of gas flow vortices within the lower section of reaction vessel 12 (FIG. 1). Creation of the gas flow vortices within reaction vessel 12 (FIG. 1), as previously described, can generally be promoted by imparting gas flow openings 46 with such a non-symmetric or random spatial distribution; although openings 46 are typically formed to be perpendicular to conical support wall 44, they may also impart additional mixing and vortices by being formed at a non-perpendicular angle with the support wall (into the page when visualized in two dimension), such that swirling action is imparted within the reaction vessel 12. In the exemplary embodiment shown in FIG. 3, gas flow openings 46 are substantially identical in size and shape; i.e., each opening 46 has a substantially circular outlet. Exemplary conical gas distributor 38 also includes twenty four substantially equally-spaced fastener openings 68 formed through mounting flange 62 to facilitate mounting between upper flange 64 of windbox 14 (FIGS. 1 and 2) and lower flange 66 of reaction vessel 12 (FIG. 1) as previously described.

The foregoing has thus provided embodiments of a fluidized bed reactor, such as a fluidized bed fluorination reactor, employing a conical gas distributor, preferably in conjunction with a solids drain pipe fluidly coupled to a central opening in the conical gas distributor, to promote the continual removal of solid aggregates from within a reaction vessel and to thereby deter the accumulate of such solid aggregates to sizes that could otherwise interfere with operation of fluidized bed reactor and ultimately force reactor shutdown. Notably, the above-described conical gas distributor also improves overall fluidization quality, gas residence time, gas-solids mixing, and heat and mass transfer as compared to traditional perforated flat plate gas distributors. The foregoing has also provided embodiments of a fluorination process carried-out utilizing a fluidized bed fluorination reactor of the type that includes a reaction vessel and a conical gas distributor having a plurality of gas flow openings formed therein. In one embodiment, the fluorination process includes the steps of supplying uranium tetrafluoride to the reaction vessel and directing fluorine gas into the reaction vessel through the conical gas distributor and along a plurality of gas flow paths that are non-parallel with the longitudinal axis of the reaction vessel to support a fluorination reactor yielding uranium hexafluoride.

By way of non-limiting illustration, an exemplary implementation of the fluidized bed reactor has been described above wherein the reactor assumed the form of a fluorine reactor utilized to covert uranium tetrafluoride to uranium hexafluoride. Embodiments of the fluidized bed reactor are especially well-suited for usage as fluorine reactors, such as the fluidized bed fluorination reactors utilized to convert uranium tetrafluoride to uranium hexafluoride, as the fluorination reaction is especially prone to the aggregation of solids due to the highly reactive nature of fluorine, the large amounts of heat generated by the fluorination reaction, and impurities present in the uranium tetrafluoride and fluidized bed materials. This notwithstanding, embodiments of fluidized bed reactor are by no means limited to usage in conjunction with fluorination processes. In this regard, the foregoing description has provided embodiments of a fluidized bed reactor for use in conjunction with a fluidizing gas, which may or may not be a fluorination reactor utilized in conjunction with a fluorine gas. Thus, the foregoing has generally provided embodiments of a fluidized bed reactor that includes a source of gaseous reactant, a reaction vessel, and a windbox fluidly coupled to the source of gaseous reactant, and a conical gas distributor fluidly coupled between the reaction vessel and the windbox. The conical gas distributor having a plurality of gas flow openings directing gaseous reactant flow from the windbox and into the reaction vessel during the reaction. In certain embodiments, and depending upon the desired reactions, the gaseous reactant may be fluorine, chlorine, hydrogen fluoride, hydrogen, hydrogen chloride, oxygen, air, steam, and mixtures thereof. In certain cases, the gaseous reactant may be diluted by an inert gas, such as nitrogen, argon, or helium.

While multiple exemplary embodiments have been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended Claims.

What is claimed is:

1. A fluidized bed fluorination reactor, comprising:
a source of fluorine gas;
a reaction vessel;
a windbox fluidly coupled to the source of fluorine gas; and
a conical gas distributor fluidly coupled between the reaction vessel and the windbox, the conical gas distributor having a plurality of gas flow openings directing fluorine gas flow from the windbox and into the reaction vessel during the fluorination process.

2. A fluidized bed fluorination reactor according to claim 1 further comprising a solids drain pipe fluidly coupled to the reaction vessel through the conical gas distributor to remove solid aggregates from the reaction vessel during the fluorination process.

3. A fluidized bed fluorination reactor according to claim 2 wherein the conical gas distributor has a solids opening formed in a central portion thereof to which the solids drain pipe is fluidly coupled.

4. A fluidized bed fluorination reactor according to claim 2 wherein the conical gas distributor comprises a conical support wall through which the plurality of gas flow openings is formed, the conical support wall converging toward the inlet of the solids drain pipe.

5. A fluidized bed fluorination reactor according to claim 4 wherein the conical support wall forms an angle with the longitudinal axis of reaction vessel between about 30 degrees and 75 degrees, as taken in cross-section along a plane parallel to longitudinal axis of the reaction vessel.

6. A fluidized bed fluorination reactor according to claim 2 wherein the conical gas distributor is disposed between a lower portion of the reaction vessel and an upper portion of the windbox.

7. A fluidized bed fluorination reactor according to claim 2 wherein the conical gas distributor comprises an annular mounting flange extending radially outward from the conical support wall and fixedly coupled to at least one of the group consisting of the windbox and the reaction vessel.

8. A fluidized bed fluorination reactor according to claim 7 wherein the windbox comprises an upper flange, wherein the reaction vessel comprises a lower flange, and wherein the annular mounting flange of the conical distributor is captured between the upper flange of the windbox and the lower flange of the reaction vessel.

9. A fluidized bed fluorination reactor according to claim 1 further comprising a fluorine inlet pipe fluidly coupling the source of fluorine gas to the windbox and having an outlet positioned so as to generally direct fluorine gas flow towards a bottom portion of the windbox and away from the conical gas distributor.

10. A fluidized bed fluorination reactor according to claim 1 wherein the plurality of gas flow openings each have an axis forming an predetermined angle with the longitudinal axis of the reaction vessel.

11. A fluidized bed fluorination reactor according to claim 10 wherein the predetermined angle is between about 30 degrees and about 75 degrees.

12. A fluidized bed fluorination reactor according to claim 10 wherein the plurality of gas flow openings are arranged as a plurality of substantially concentric rings.

13. A fluidized bed fluorination reactor according to claim 12 wherein the plurality of substantially concentric rings is angularly staggered.

14. A fluidized bed fluorination reactor according to claim 10 wherein the plurality of gas flow openings is non-symmetrical.

15. A fluidized bed reactor, comprising:
a gaseous reactant;
a reaction vessel;
a windbox fluidly coupled to a source of the gaseous reactant; and
a conical gas distributor fluidly coupled between the reaction vessel and the windbox, the conical gas distributor having a plurality of gas flow openings directing gaseous reactant flow from the windbox and into the reaction vessel during the reaction.

16. A fluidized bed reactor according to claim 15 wherein the gaseous reactant is selected from the group consisting of fluorine, chlorine, hydrogen fluoride, hydrogen, hydrogen chloride, oxygen, air, steam, and mixtures thereof.

17. A fluidized bed reactor according to claim 16 further comprising an inert gas diluting the gaseous reactant.

18. A fluorination process carried-out utilizing a fluidized bed fluorination reactor of the type that includes a reaction vessel and a conical gas distributor having a plurality of gas flow openings formed therein, the fluorination process comprising the steps of:
supplying uranium tetrafluoride to the reaction vessel; and
directing fluorine gas into the reaction vessel through the conical gas distributor and along a plurality of gas flow paths that are non-parallel with the longitudinal axis of the reaction vessel to support a fluorination reaction yielding uranium hexafluoride.

19. A fluorination process according to claim 18 further comprising the step of removing solid aggregates from the reaction vessel through a solids drain pipe fluidly coupled to a central opening provided through the conical gas distributor.

20. A fluorination process according to claim 18 wherein the fluidized bed fluorination reactor further comprises a windbox fluidly coupled to the reaction vessel through the conical gas distributor, and wherein the fluorination process further comprises the step of conducting the reactive gas into the windbox along a path generally directed towards a lower portion of the windbox and away from the conical gas distributor.
